(19) United States
(12) Patent Application Publication
(10) Pub. No.: US 2004/0096719 A1
(43) Pub. Date: May 20, 2004

(54) Passive vapor exchange systems and techniques for fuel reforming and prevention of carbon fouling

(76) Inventors: Prabhakar Singh, Richland, WA (US); Ralph E. Williford, Kennewick, WA (US); Brian K. Hatchell, W. Richland, WA (US)

Correspondence Address: Woodard, Emhardt, Moriarty, McNett & Henry LLP, Bank One Center/Tower, Suite 3700, 111 Monument Circle, Indianapolis, IN, 46204-5137, US

(21) Appl. No.: 10/636,394

(22) Filed: Aug. 7, 2003

Related U.S. Application Data
(60) Provisional application No. 60/402,239, filed on Aug. 7, 2002.

(51) Int. Cl. H01M 8/12; H01M 8/04

(52) U.S. Cl. 429/30; 429/26; 429/20; 429/38; 429/13

(57) ABSTRACT

A solid oxide fuel cell system 20 operates on a hydrocarbon fuel and includes a solid oxide fuel cell 30, a fuel reformer 30 and a humidifier 26. The humidifier passively transfers water from a exhaust stream 35 of the solid oxide fuel cell to an inlet stream 27 to the fuel reformer 30.

### RELATED APPLICATION DATA

This application claims the benefit of U.S. Provisional Application Ser. No. 60/402,239 filed Aug. 7, 2002 and titled Methods and Systems for Fuel Reforming and Prevention of Carbon Fouling, the disclosure of which is hereby incorporated by reference.

### GOVERNMENT RIGHTS

This invention was made with Government support under Contract Number DE-AC06-76RLO1830 awarded by the U.S. Department of Energy. The Government has certain rights in the invention.

### TECHNICAL FIELD

The present invention is generally related fuel reforming for fuel cells, and more particularly, but not exclusively, is related to the passive humidification of a fuel reformer inlet stream with the exhaust gas from a solid oxide fuel cell.

### BACKGROUND

Fuel cell devices are known and used for the direct production of electricity from standard fuel materials including fossil fuels, hydrogen, carbon monoxide and the like by converting chemical energy of a fuel into electrical energy. Fuel cells typically include a porous fuel electrode (also referred to as the “anode”), a porous air electrode (also referred to as the “cathode”), and a solid or liquid electrolyte therebetween. In operation, gaseous fuel materials are contacted, typically as a continuous stream, with the anode of the fuel cell system, while an oxidizing gas, for example air or oxygen, is allowed to pass in contact with the cathode of the system. Electrical energy is produced by electrochemical combination of the fuel with the oxidant. Because fuel cells convert the chemical energy of the fuel directly into electricity without the intermediate thermal and mechanical energy step, their efficiency can be substantially higher than that of conventional methods of power generation.

Solid oxide fuel cells (SOFCs) employing a dense ceramic electrolyte are currently considered as one of the most attractive technologies for electric power generation. In a typical SOFC, a solid electrolyte separates the porous metal-based anode from a porous metal or ceramic cathode. Due to its mechanical, electrical, chemical and thermal characteristics, yttria-stabilized zirconium oxide (YSZ) is currently the electrolyte material most commonly employed for SOFC's. The anode in a SOFC is typically made of a nickel-YSZ cermet, and the cathode is typically made of lanthanum manganites, lanthanum ferrites or lanthanum cobaltites. In such a fuel cell, an example of which is shown schematically in FIG. 1, the fuel flowing to the anode reacts with oxide ions to produce electrons and water. The oxygen reacts with the electrons on the cathode surface to form oxide ions that migrate through the electrolyte to the anode. The operating temperature is typically in the range of about 600-1000° C. so as to provide adequate ion diffusivity. The electrons flow from the anode through an external circuit and then to the cathode. The movement of oxygen ions through the electrolyte maintains overall electrical charge balance, and the flow of electrons in the external circuit provides useful power. In order to provide commercially useful quantities of power for most applications, a plurality of individual fuel cell units (each composed of a single anode, a single electrolyte, and a single cathode) are electrically connected to each other, for example in a stack arrangement.

The fuel cell system schematically illustrated in FIG. 1 depicts operation on hydrogen and carbon monoxide. Fuel cell systems that operate on hydrocarbon fuels, such as methane and natural gas, require reforming of the fuel stream prior to introduction to the fuel cell to generate hydrogen from the hydrocarbon. Fuel reforming techniques currently employed include steam reforming, autothermal reforming, and partial oxidation. Of these, steam reforming and autothermal reforming are in general more efficient than partial oxidation (and catalytic partial oxidation) and do not require the addition of air to the reformer, as does partial oxidation. However, both steam reforming and autothermal reforming typically require humidification of the fuel stream, for example to prevent hydrocarbon cracking and resultant carbon fouling.

Such humidification in existing hydrocarbon fuel cell systems typically employs external water sources or the active recirculation of a portion of the fuel cell exhaust into the reformer inlet. Active recirculation occurs at high temperatures, requiring high temperature valves, pumps, and construction materials that add to the overall system cost, as well as increasing the parasitic power loss. A high temperature recirculation system also adds to the volume and weight, a factor of considerable concern for mobile fuel cell applications.

Accordingly, there is a need for improvements in fuel cell design and operation to efficiently and cost effectively provide humidification for fuel cells running on hydrocarbons. The present invention addresses this need.

### SUMMARY

The present invention provides systems and techniques for humidifying the hydrocarbon inlet stream in a solid oxide fuel cell system. While the actual nature of the invention covered herein can only be determined with reference to the claims appended hereto, certain aspects of the invention that are characteristic of the embodiments disclosed herein are described briefly as follows.

According to one aspect, a solid oxide fuel cell system comprises a solid oxide fuel cell having a layer of ceramic ion conducting electrolyte disposed between a conducting cathode and a conducting anode, a fuel flow path for supplying a fuel stream to the anode, and an oxidant flow path for supplying an oxidant stream to the cathode. A capillary humidifier passively humidifies the fuel stream with exhaust from the fuel cell. The capillary humidifier comprises a capillary member disposed between a first flow path upstream from the fuel flow path and a second flow path downstream from the fuel flow path.

Acccording to another aspect, a system for generating power comprises a solid oxide fuel cell, a fuel reformer, and a capillary humidifier, wherein the capillary humidifier is configured to passively transfer water from an exhaust stream of the solid oxide fuel cell to an inlet stream to the fuel reformer.

According to a still further aspect, a method for operating a solid oxide fuel cell system with a hydrocarbon fuel comprises humidifying a hydrocarbon fuel stream provided to a fuel reformer of the solid oxide fuel cell system by passively transferring water from an exhaust gas of the fuel cell to the hydrocarbon fuel stream.

These and other aspects are discussed below.

### BRIEF DESCRIPTION OF THE FIGURES

Although the characteristic features of this invention will be particularly pointed out in the claims, the invention itself, and the manner in which it may be made and used, may be better understood by referring to the following description taken in connection with the accompanying figures forming a part thereof.

FIG. 1 is a general schematic diagram showing the function of a solid oxide fuel cell.

FIG. 2 is a general schematic diagram of a solid oxide fuel cell system according to one aspect of the invention.

FIG. 3 is a schematic diagram of a capillary humidifier for use in the FIG. 3 fuel cell system.

FIG. 4 is an enlarged sectional view of the capillary humidifier of FIG. 3.

FIG. 5 is a perspective view of a tubular capillary member having a roughened outer surface.

FIG. 6 is a flow chart illustrating the iterative scheme utilized in the computer program of the Examples.

FIG. 7 is a schematic illustration of the counter flow capillary humidifier used in the experiments of the Examples.

FIG. 8 is a partial cutout perspective view of the counter flow capillary humidifier of FIG. 7.

FIG. 9 is an exemplary plot of water vapor exchanged in standard liters per minute (SLPM) vs. bulk temperature difference between the condenser and evaporator flow streams as calculated (line) and measured (circles) according to the Examples.

FIG. 10 is an exemplary plot of mass flux exchanged (g/min) vs. bulk temperature difference between the condenser and evaporator flow streams as calculated (lines) and measured (symbols) according to the Examples.

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended. Alterations and further modifications in the illustrated devices, and such further applications of the principles of the invention as illustrated herein are contemplated as would normally occur to one skilled in the art to which the invention relates.

In one form, the present invention provides a solid oxide fuel cell system including a water vapor exchanger that passively transfers water vapor from the solid oxide fuel cell exhaust stream to the fuel supply stream while maintaining a liquid diffusion barrier between the two sides. In one implementation of the invention, this water vapor transfer can provide all the water needed for hydrocarbon fuel reforming while the diffusion barrier prevents exhaust gases from entering and fouling the fuel stream.

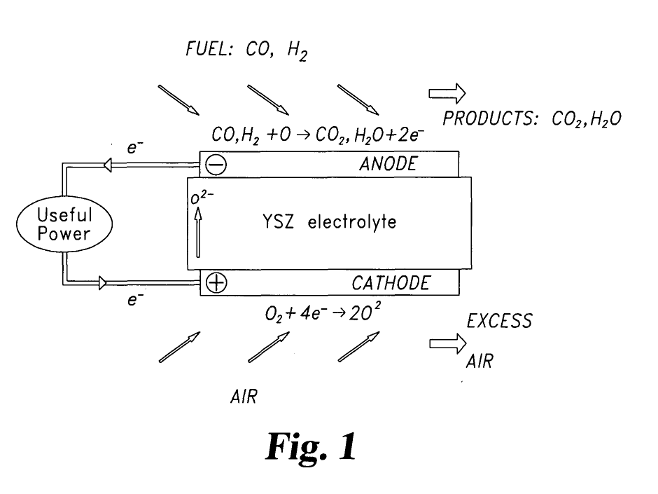

Turning now to FIG. 1, an exemplary solid oxide fuel cell system 20 according to an aspect of the present invention is schematically depicted. System 20 is configured to operate on pressurized natural gas (PNG) as the fuel and air (AIR) as the oxidant. Flowmeter 21 controls the flow of PNG to a desulfurizer 22 (DS), which reduces the sulfur content of the fuel stream. Any of the well know techniques for reducing sulfur content can be employed, for example absorbing the sulfur with an absorbent such as a zeolite.

The outlet of the desulfurizer 22 is split into a startup fuel branch 48 and a SOFC fuel branch 23. The fuel branch 23 is pressurized by compressor 24 and then passed via outlet stream 25 through a first side of humidifier 26. The outlet 27 from this first side of humidifier 26 (i.e. the fuel side or evaporator side) passes through the first side of heat exchanger 28 (HX) and, after being heated thereby enters fuel processor 30 (FP) via path 29. Fuel processor 30 is a steam reformer or autothermal reformer which converts hydrocarbons (in this case natural gas) to a hydrogen rich fuel stream which can be processed by a solid oxide fuel cell (SOFC) to produce electrical energy. The fuel processor 30 can be any of various steam reformer or autothermal reformers known in the art, for example those described in U.S. Pat. Nos. 5,527,631 and 5,686,196 to Singh et al. which are each hereby incorporated by reference to the extent not inconsistent with the present disclosure. In one form, the fuel processor 30 is a catalytic fuel reformer employing a commercially available fuel reforming catalyst material, such as catalytic Ni, Pt or MgO on a porous alumina support.

Having been converted to a suitable SOFC fuel inlet, the outlet stream 31 of fuel processor 30 is fed to the anode of solid oxide fuel cell 32 (SOFC). The anode exhaust 33 from the SOFC passes through one side of heat exchanger 34 and, after cooling, outlets through flow path 35. This cooled fuel exhaust then passes through a second side of humidifier 26 (i.e. the exhaust side or condenser side). The outlet 37 from this side of humidifier 26 is fed through condenser 38 where remaining water is extracted via line 40 yielding a carbon dioxide rich exhaust gas in flow path 39.

Flowmeter 41 controls the oxidant (air) flow to the system 20. The SOFC air side branch 42 passes through compressor 43 and is supplied via line 44 to a second side of heat exchanger 34. After being heated, the air follows path 45 into the cathode side of SOFC 32. The air exhaust 46 from SOFC 32 is connected to a second side of heat exchanger 28 and outlets through path 47.

The startup fuel branch 48 and air branch 49 are provided to feed a fuel processor 50 which is used to heat the SOFC 32 to its operating temperature. Fuel processor 50 performs catalytic partial oxidation (CPOX) utilizing a fuel-air mixture as its inlet stream. The heated partially oxidized exhaust of fuel processor 50 is routed through line 54 to supply a heated fluid stream to the air side of SOFC 32 via the second side of heat exchanger 34. Optionally, the outlet of fuel processor 50 is routed through the fuel side of SOFC 32. Once the SOFC has reached a suitable temperature, fuel processor 50 can be shut off with valve 56.

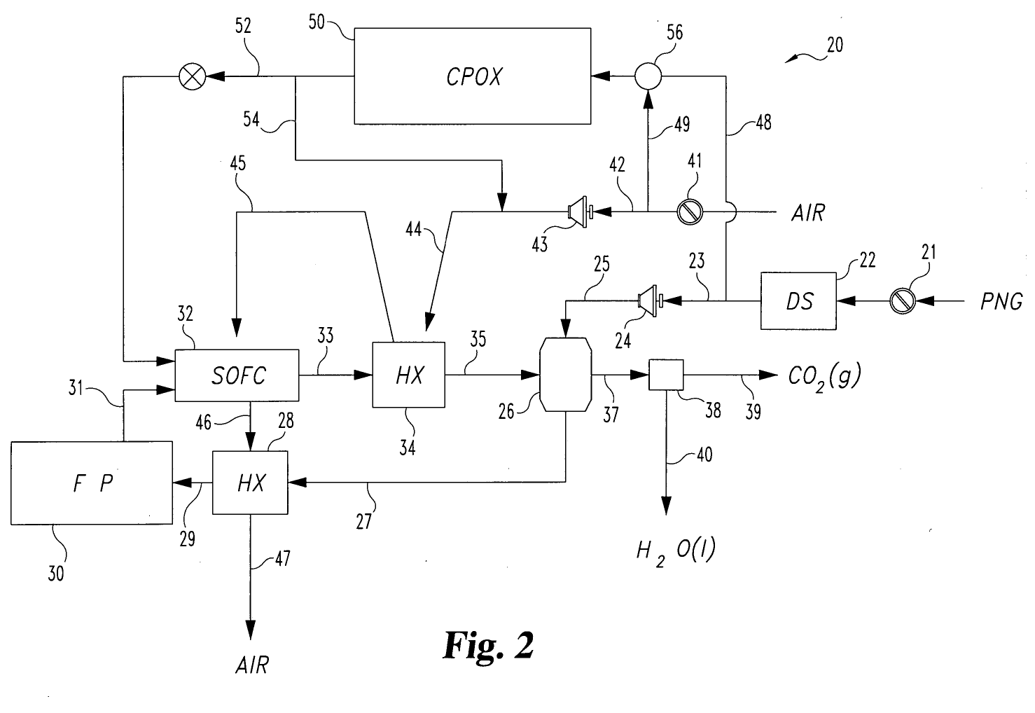

It is of course to be understood that FIG. 2 is a simplified schematic and that one or more of the operations depicted in FIG. 2 might represent the operation of one or more fluid processing units as appropriate. For example, in one aspect, the fuel processor 30 is integral with the fuel cell 32. In another aspect a combustor can be used in place of or in addition to the heat exchangers, which may be single exchangers or multiple exchangers in series. Moreover, while valves 21 and 41 are described as controlling the fuel and air flow respectively, appropriate valves can be provided throughout the system if more of different control is desired.

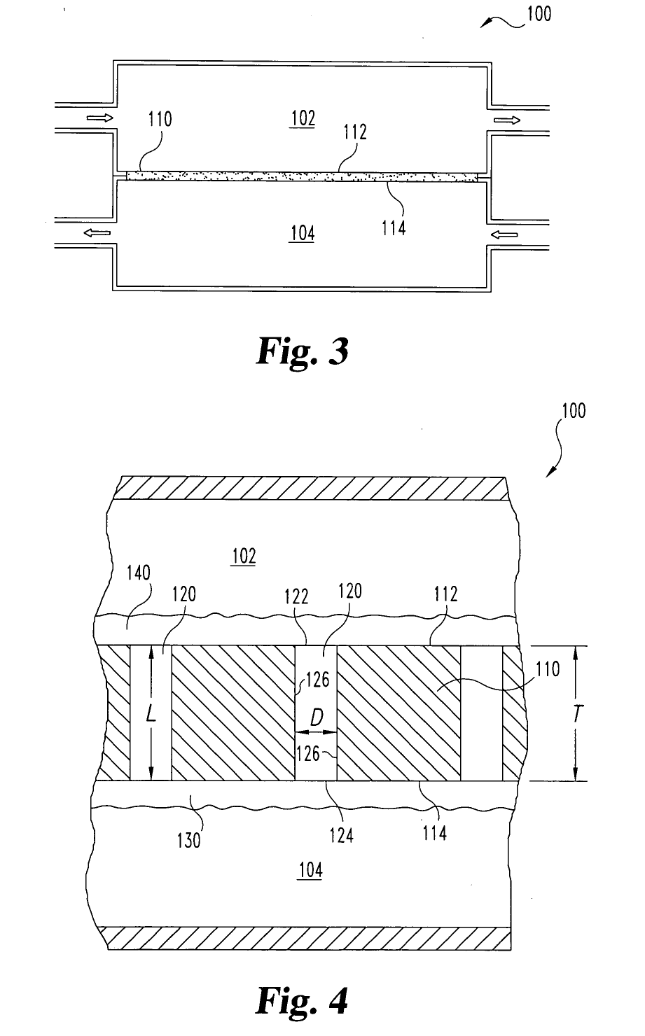

Turning now to FIGS. 3 and 4, further aspects of humidifier 26 are illustrated. Humidifier 26 is a capillary humidifier that functions to passively transfers water between first 102 and second 104 fluid streams. System 100 is a unit illustrating a single pass wherein streams 102 and 104 are contained in flow paths positioned on opposing sides of capillary member 110 in counterflow arrangement. However, it is to be understood that humidifier 26 can be composed of a plurality of units 100 where the flow is cross flow, counter-flow, co-flow, or any useful flow pattern.

Capillary member 110 defines a plurality of capillary passages 120 spanning between first 112 and second surfaces 114 of the member 110 facing the first 102 and second 104 fluid streams respectively. Each of the passages 120 has a length L measured between a first opening 122 in the first surface 112 and a second opening 124 in a second surface 114 and a diameter D measured between interior walls 126. As illustrated, passages 120 are shaped to generally form right cylinders having a length L about equal to the thickness T of the capillary member 110. In other aspects, passages are other shapes, such as tapered or tortuous. In one aspect, the passage have an aspect ratio L/D of at least 1, for example between 1 and 10. As depicted, the capillary passages 120 are each of substantially uniform size and configuration, i.e. they are substantially identical. In other aspects, the capillary passages are non-uniform, for example having diameters D that define a size distribution.

The capillary passages 120 serve to transport water from the first 102 to second 104 fluid stream (or vice versa) by capillary flow, which is the flow of a liquid through small passageways in a solid caused by the liquid-solid molecular attraction. In the SOFC system of FIG. 1, this transfer of water is from the exhaust stream 35 coming from the anode side of the SOFC 32 to the fuel stream 27 leading to the fuel processor 30 and then the anode side of the SOFC 32. Each of these streams are gaseous, and thus it is expected that, at steady state operation, a layer of condensed water 140 will form on some or all of surface 112. This condensed water 140 will be wicked through passages 120 and form a layer 130 covering some or all of surface 130 wherein it will evaporate into stream 104.

While it is not necessary that layers 140 and 130 cover any particular portion of surfaces 120, humidifier 26 is configured to assure that passages 120 remain at least partially filled with water at all relevant times such that there is no gas flow between stream 102 and 104. Despite a pressure differential between stream 102 and 104, the only transfer of material between the streams should be the wicking of the water. This is referred to as the formation of a diffusion barrier between the two streams, since the solid-liquid barrier of the member 110 and the water in passages 120 blocks gaseous materials, such as carbon dioxide in the SOFC exhaust, from transferring from stream 102 to stream 104 (other than as dissolved materials transferred as a result of the wicking of water).

Along with the size and configuration of the passages 120, the material of the passages influences its interaction with water and can influence the overall wicking ability of the passages. Accordingly, in another aspect, the interior walls 126 of passages 120 are composed of a different material to encourage wicking. The different material can be applied as a coating after the openings 120 are formed in member 110, or member 110 can be formed in layers such that the layers of selected material are exposed upon formation of passages 120 through member 110.

The capillary member 110 is formed of a solid material capable of supporting the capillary passages, withstanding the operating environment, and providing adequate wicking ability as necessary. The passages 120 can have a large enough diameter D to avoid excessive clogging, and the member 110 can be sturdy enough to support the operating pressure differential between streams 102 and 104 as well as an offline blowout procedure to unclog passages 120 should such maintenance be necessary. Candidate materials for member 110 include rigid inorganic materials, such as metals, alloys and ceramics. More particular examples include stainless steel, nickel alloys, coboalt alloys and superalloys fabricated from iron, nickle or cobalt. Suitable diameter D of passageways in stainless steel or other materials can be between about 0.1 μm and 5 μm.

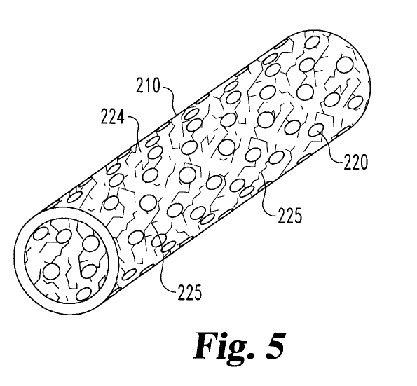

In other aspects of the invention, the capillary member 110 is non-planar. Turning now to FIG. 5, a tubular capillary member 210 is depicted. Just as planar member 110 operates to passively transfer water between fluid stream on its opposing sides, tubular capillary member acts to passively transfer water between fluid streams flowing inside and outside the member 210.

In addition to defining the capillary passages 220, member 210 schematically illustrates another aspect of the invention which may be implemented for any configuration of capillary member (planar, tubular, or other shapes). Member 210 includes surface features 225 on its exterior surface 224. These surface features 225 serve to increase the surface area of the outer surface 224, thereby increasing the area for evaporation or condensation, depending on whether the exterior surface 224 is facing the fuel or exhaust stream respectively. Features 225 can be fins, projections, roughened portions or any other structures that substantially increase the surface area of surface 224, and can be provided on any one or both sides of a capillary member, regardless of the shape of the capillary member.

In other forms, the capillary member is provided by polymeric or fibrous materials. For example the humidifiers depicted in U.S. Pat. No. 6,471,195 to Shimanuki et al. which are described with respect to supplying water to the polymer electrolyte membrane in solid polymer type fuel cells, might be adapted for use in place of humidifier 26 of FIG. 1 according to the principles of the present invention. In still further aspects, the humidifiers described in US Pub. No. 2002/0155328 to Smith et al. are employed. The above Shimanuki patent and Smith publication are hereby incorporated by reference to the extent not inconsistent with the present disclosure.

While system 20 can be operated in any manner to generate useful power, in one mode of operation, system 20 is operated such that substantially all of the fuel is converted, where fuel conversion is expressed relative to the molar percent of hydrogen in the outlet 33, with 0% hydrogen being total or 100% conversion. As system operates at or near 100% conversion, the exhaust gas of the fuel cell in line 33 is primarily water and carbon dioxide. Recapture of water via humidifier 26, together with the removal of water in condenser 38 permits the provision of an exhaust gas at 39 that is substantially pure carbon dioxide, permitting its cost effective capture for other uses. It is contemplated that exhaust streams 39 that are above 90 mole % CO₂, for example between 95-100 mole % can be achieved. In addition, the removed water 40 can be used for other purposes, such as as drinking water.

Reference will now be made to examples illustrating a specific computational and experimental design approach that was employed. It is to be understood, however, that these examples are provided for illustration and that no limitation to the scope of the invention is intended thereby. Specifically, while the examples refer to the design and scale up of certain capillary humidifiers, other designs and scale up (or scale down) techniques can be employed as would occur to those of skill in the art.

### EXAMPLES

Computer Simulations

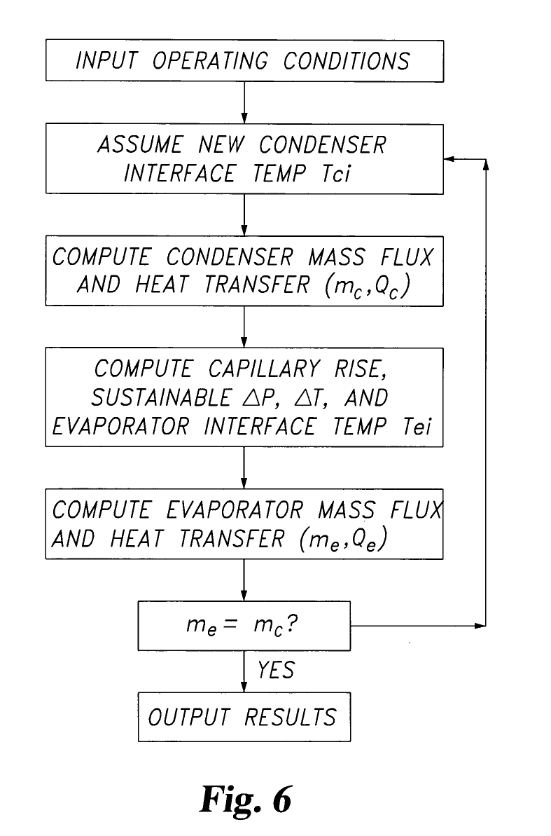

A computational design approach employed conventional engineering correlations for mass transfer during condensation and evaporation of water vapor. The structure of the simulation code is shown by the flow diagram in FIG. 6, where an iterative solution method is outlined. The iterations proceed by assuming a temperature (T_{ci}) for the condensate/gas interface temperature on the condenser (SOFC exhaust) side. The mass flow rate of the condensed vapor (m_{c}) is computed from the mass flux coefficient (K_{c}) given by eq. (1)

K_{c}=j_{D}Gₘ/(Sc^{2/3}Pₗₘ), (1)

where j_{D} is the correlation from curve 5 (for flat plates) shown in FIG. 30.1 of J. R. Welty, C. E. Wicks, R. E. Wilson, Fundamental of Heat, Mass and Momentum Transfer, Wiley, New York, 1969, Chapter 30, Gₘ is the mass flow rate of the exhaust gas stream, Sc is the Schmidt number, and Pₗₘ, is the log mean pressure difference of the carrier gas (air in the experiments described below) give by eq. (2),

Pₗₘ=[(P_{bulk}−P_{interface})/1n(P_{bulk}/P_{interface})]ₐᵢᵣ. (2)

The interface pressure is defined by the temperature-dependent vapor pressure of water, for which a correlation was fitted to standard data taken from D. R. Lide, CRC Handbook of Physics and Chemistry, 76^{th} ed., CRC Press, New York, 1995. The mass flow rate of condensate was computed from the pressure difference of the water vapor between the interface and the bulk gas stream according to eq. (3),

m_{c}=K_{c}[P_{bulk}−P_{interface}]_{vapor.} (3)

The Chilton-Colbum analogy relates mass transfer to heat transfer, and was used to compute the heat transfer (Q_{c}) across the capillary medium due to the condensation phase change. The temperature drop across the capillary medium (ΔT) was then computed by assuming that heat transfer occurred through the parallel path presented by the water in the capillary pores (assumed to be spaced four pore radii apart on centers) and the stainless steel of the chosen capillary medium. The capillary rise was computed using the Young-Laplace equation [I. N. Levine, Physical Chemistry, McGraw-Hill, N.Y., 1988, p. 363], and was found to be about 16 cm for the material and conditions utilized below. This is expected to be more than adequate to ‘pump’ the condensed water from the condenser (exhaust) to the evaporator (fuel) side of the exchanger in contemplated applications.

The maximum gas pressure differential (ΔP) sustainable across the capillary medium was calculated using the same equation (Young-Laplace equation), and was found to be about 7 psi. This relatively high value is important for the operation of the vapor exchanger in industrial settings, where startup or load following conditions may cause pressure imbalances during transients. A pressure difference above the sustainable ΔP would force the water from the capillaries, defeating the diffusion barrier. Designing the exahanger to have a relatively high sustainable pressure difference assures that the capillary medium is fully wetted during normal operation and provides a degree of ‘robustness’ in practice.

Using the above calculated temperature drop across the capillary medium (generally less than 1 degree Celsius), the water/gas interface temperature (Tₑᵢ) on the evaporator side is then computed, and subsequently used to calculate the evaporator mass flux (mₑ) according to eq. (4), which is analogous to eq. (3) for the condenser calculation shown above:

mₑ=Kₑ(P_{interface}−P_{bulk})_{vapor.} (4)

Again the associated heat transfer (Qₑ) was computed using the Chilton-Colbum analogy. The two mass fluxes are then compared. If agreement is satisfactory, the code outputs the results. If there is disagreement, the interation resumes with an improved estimate of the condenser interface temperature T_{c}.

The code was programmed to simulate a counterflow exchanger, and performs the above calculations beginning at the location of the condenser (exhaust) input and evaporator (fuel) output. The iterative solution is found for a small segment of the exchanger, and the resulting gas compositions are used as input for the next segment. However, due to the small size of the sample tested, only one segment was necessary for these calculations. Axial heat flow considerations (along the flow streamlines) were limited to that transferred by the gases, and the solid capillary material was assumed to transfer heat only across its thickness.

It was assumed that the condensation and evaporation processes occurred from contiguous water films on the surface of the capillary medium. Additional calculations were performed which assumed that the evaporation occurred from the area of the capillary pores alone, rather than from a contiguous water film. For the experimental setup discussed below, calculations based on the assumption of evaporation from the pores alone underestimated the measured mass flux by factors of about 2. The water film assumption is also consistent with the calculation of a large capillary rise as described above, which would ensure that, during steady state operation, excess water would always be available on the evaporator side.

The agreement between the heat transfer from the condenser and evaporator sides of the exchanger using the water film assumption and the Chilton-Colbum analogy was within 4%, further indicating that the computational approach was successful. Finally, it should be noted that a second method for calculating condensation mass transfer known as the Colbum-Hougen method [A. P. Colbum, O. A. Hougen, Ind. Eng. Chem. 26 (11) (1934) 1178-1182] was employed for comparative purposes, but it noticeably underpredicted the measured condensate mass transfer.

Laboratory Experiments

Bench scale experiments were performed to test the passive humidifier concept and to obtain data for calibration. The test objectives, set-up, and results are discussed below.

The primary test objective was to measure the sustainable rate of water transfer between a dry air stream and a humid air stream separated by a porous capillary membrane. The test parameters, such as channel length, air velocity, and temperature, were chosen to permit a small benchtop test, and to provide meaningful data to calibrate the computational model. The processes of condensation and evaporation can occur at different rates and result in unsatisfactory circumstances. Excessive evaporation can lead to partial drying of the liquid barrier, and mixing between the gas streams. Excessive condensation can cause drop-wise condensation and moisture buildup in the exhaust line. Therefore, a process in which condensation is balanced with evaporation is highly desirable.

A secondary objective was to determine the maximum differential pressure that can be maintained between the two air streams by the porous capillary membrane. The fuel gas stream will be at a higher pressure than the exhaust, so the membrane should be able to sustain a pressure differential without compromising the diffusion barrier provided by the wetted membrane.

Experimental Apparatus

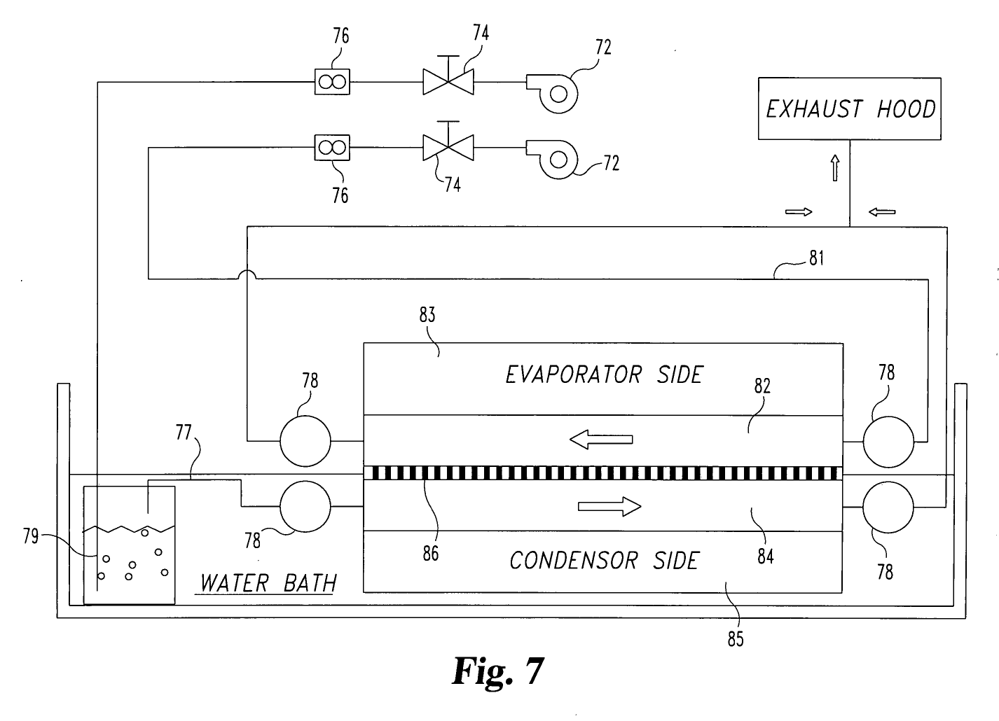

A diagram of the test set-up is shown in FIG. 7. Small capacity air pumps 72 with flow control valves 74 (maximum flow rate 100 liters/hr) provided independent flow through evaporator side 82 and condenser side 84 of humidifier 80. Tapered tube flow meters 75, 76 (Dwyer model VFB-50) were used to measure the flow rate of dry air. The condensing-side air stream 77 was connected to a bubbler 79 to raise the humidity to 100% to simulate the SOFC exhaust stream. Humidity sensors 78 from the Controls Company were installed upstream and downstream of the condenser 84 and evaporator 82 sides to measure changes in temperature and humidity. The humid air 77 and dry air 81 streams were connected to the condenser and evaporator sides 84, 82 of the capillary humidifier 80, respectively, in a cross-flow arrangement, with the condensing side on the bottom.

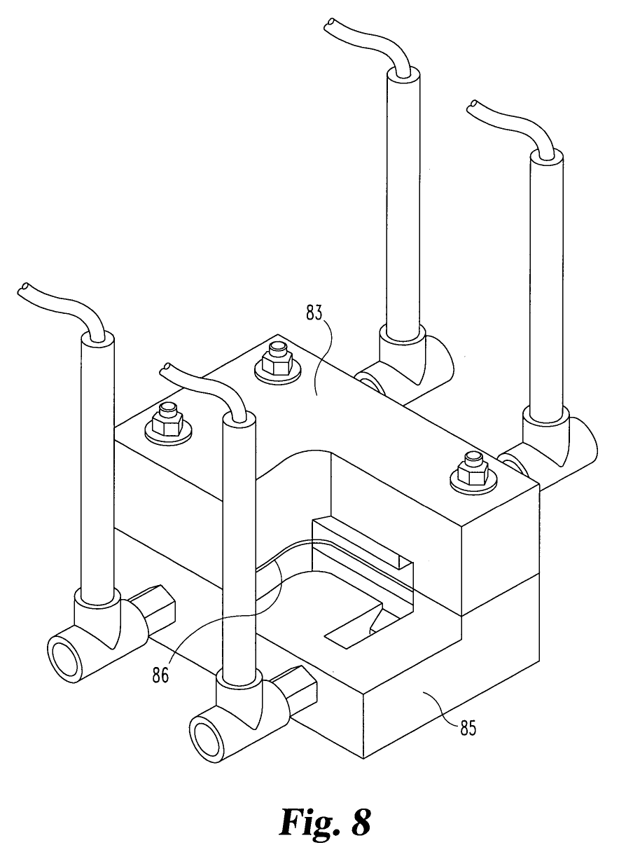

In the capillary humidifier 80, a porous sintered stainless steel panel 86 was sandwiched between two LEXAN blocks 83, 85 (see FIG. 8). The stainless steel panel was 2 micron grade, 0.062 inches (1.57 mm) thick and was procured from the Mott Corporation. Air passages were cut into both LEXAN blocks to create a channel 7 cm long with a 1-cm by 1-cm square cross section. The capillary humidifier was partially submerged in a hot water bath to increase the temperature and saturation pressure of the air and to generate a temperature gradient across the membrane panel, thus simulating the fuel-exhaust temperature gradient in a SOFC.

Prior to testing, the evaporator outlet was plugged and a small amount of water was introduced to the evaporator side of the capillary humidifier. The evaporator side was then pressurized to approximately 1 psi to infuse water into the membrane. For each set point, the evaporator was operated for at least 20 minutes to allow the process to reach steady-state conditions.

Comparison of Test Results with Model Predictions

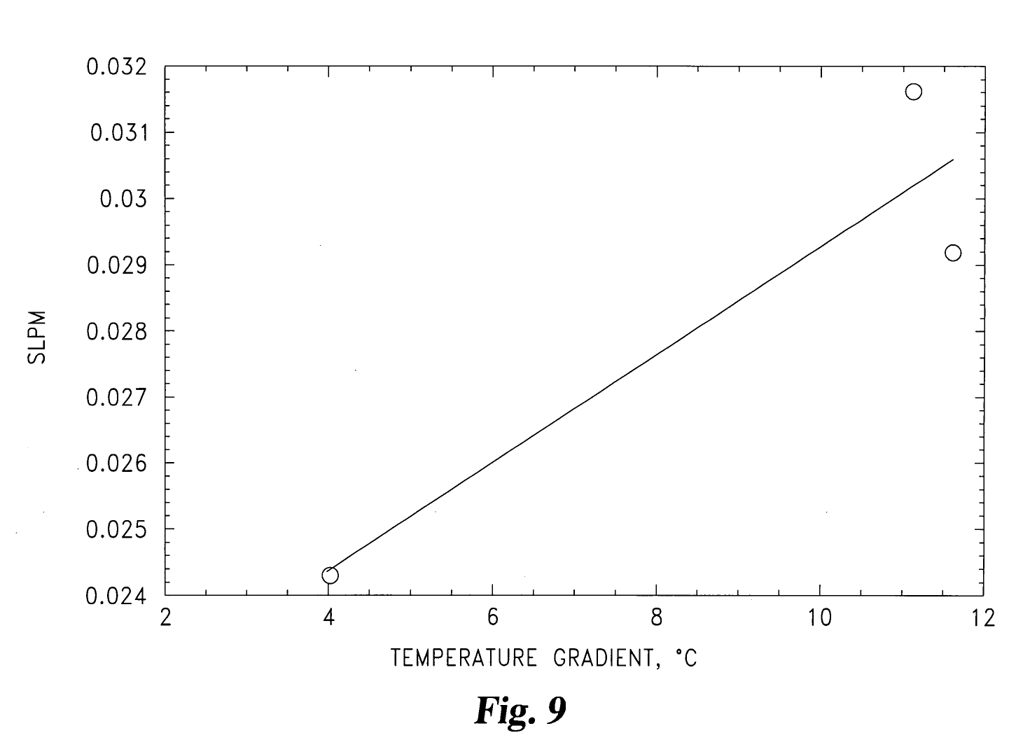

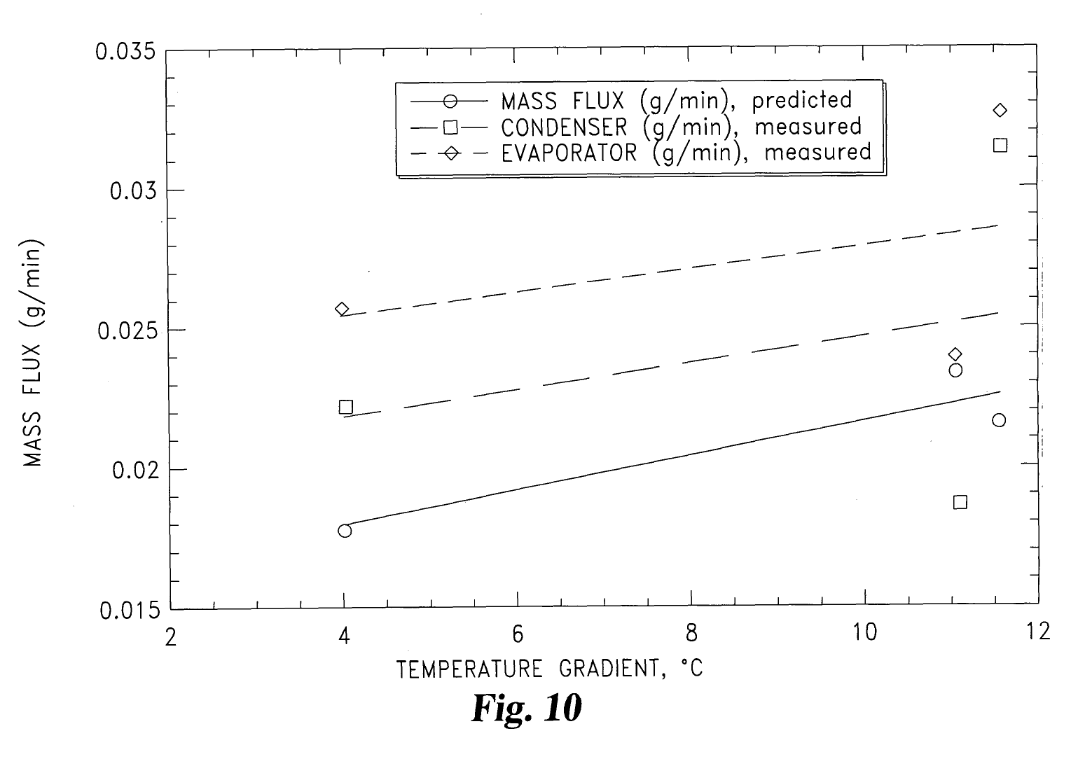

Results from three experiments are shown in Tables 1-3 and performance is summarized in FIGS. 9 and 10. For the first and second experiments (cases 1 and 2), the flow rate of dry air was held constant at 1.5 SCFH and 3.0 SCFH, respectively, on both the condenser and evaporator sides of the humidifier. For the third case, the flow rate of dry air was 3 SCFH on the evaporator side and 1.5 SCFH on the condenser side. The water bath temperature was maintained at 50° C. The humidity level decreased on the condenser side and increased on the evaporator side, as expected. The rate of water transport was between 3 and 22% higher on the evaporator side, indicating that evaporation was more efficient than condensation. Sustainable pressure differentials were in agreement with calculations.

TABLE 1
Results from the first experiment. Table entries are given
as experimental/predicted where appropriate.

| Case 1 | Condenser (exh. side) | Evaporator (fuel side) |
|---|---|---|
| Air velocity (cm/sec) | 11.8 | 11.8 |
| Air pressure (atm) | 1.10 | 1.08 |
| Air Temp (C) | 46.4/46.0 | 42.6/42.0 |
| Air/liquid interface temp | 42.7 | 42.3 |
| (C) - predicted | | |
| Mole Fr. Water - inlet | 0.1048/0.1048 | 0.0117/0.0251 |
| Mole Fr. Water - outlet | 0.0692/0.0739 | 0.0578/0.0578 |
| Mass flow rate (g/min) | 0.0222/0.0178 | 0.0257/0.0178 |
| (prediction error %) | −19% | −31% |
| Exchange rate (SLPM) | 0.0243 | 0.0243 |
| Sustainable pressure (psi) | 7.08 | 7.08 |

TABLE 2
Results from the second experiment. Table entries are
given as experimental/predicted where appropriate.

| Case 2 | Condenser (exh. side) | Evaporator (fuel side) |
|---|---|---|
| Air velocity (cm/sec) | 23.6 | 23.6 |
| Air pressure (atm) | 1.09 | 1.05 |
| Air Temp (C) | 44.7/44.7 | 33.1/33.1 |
| Air/liquid interface temp | 39.0 | 38.5 |
| (C) - predicted | | |
| Mole Fr. Water - inlet | 0.0961/0.0961 | 0.0107/0.0207 |
| Mole Fr. Water - outlet | 0.0707/0.775 | 0.0405/0.0405 |
| Mass flow rate (g/min) | 0.0314/0.0215 | 0.0326/0.0215 |
| (prediction error %) | −31% | −34% |
| Exchange rate (SLPM) | 0.0292 | 0.0292 |
| Sustainable pressure (psi) | 7.2 | 7.2 |

TABLE 3
Results from the third experiment. Table entries are
given as experimental/predicted where appropriate.

| Case 3 | Condenser (exh. side) | Evaporator (fuel side) |
|---|---|---|
| Air velocity (cm/sec) | 11.8 | 23.6 |
| Air pressure (atm) | 1.09 | 1.05 |
| Air Temp (C) | 44.4/44.4 | 33.3/33.3 |
| Air/liquid interface temp | 37.5 | 36.9 |
| (C) - predicted | | |
| Mole Fr. Water - inlet | 0.0937/0.0937 | 0.0104/0.0109 |
| Mole Fr. Water - outlet | 0.0634/0.0532 | 0.0325/0.0325 |
| Mass flow rate (g/min) | 0.0186/0.0233 | 0.0239/0.0233 |
| (prediction error %) | +25% | −2% |
| Exchange rate (SLPM) | 0.0316 | 0.0316 |
| Sustainable pressure (psi) | 7.2 | 7.2 |

As expected, exchanger performance increases with the temperature difference from the condenser to evaporator sides (FIG. 9). This is consistent with the Chilton-Colburn analogy, which relates the heat transfer to the mass transfer. Since heat transfer increases with temperature difference, so would the mass transfer.

FIG. 10 provides the most useful information for calibrating the design code. There it can be seen that the evaporator is more efficient than the condenser, since the former has a higher mass transfer rate than the latter. The expectation is that the evaporator side will require a smaller temperature gradient (from the water/vapor interface to the bulk gas stream) to produce the same mass flux as the condenser. This is advantageous because the SOFC inlet fuel temperature is much easier to control than the exhaust.

As will be understood by those of skill in the art, comparison of results from the computational and experimental approaches can be used for calibration, performance prediction, and scale up. For example, the above described simulation code underpredicted the experimental performance by about 28% on the average, indicating that a calibration factor of about 1.28 might be appropriate for the present geometry. Alternative exchanger designs, such as tube in shell configurations, could be investigated by substituting the appropriate mass transfer correlation from Table 30.1 of Welty et al. above.

### CLOSURE

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding. Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with fluid transfer, it should be understood to comprehend singular or plural and one or more fluid channels as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

What is claimed is:

1. A solid oxide fuel cell system comprising:
a solid oxide fuel cell comprising a layer of ceramic ion conducting electrolyte disposed between a conducting cathode and a conducting anode, the fuel cell having a fuel flow path therethrough for supplying a fuel stream to the anode and an oxidant flow path therethrough for supplying an oxidant stream to the cathode; and
a capillary humidifier for passively humidifying the fuel stream with exhaust from the fuel cell, the capillary humidifier comprising a capillary member disposed between a first flow path upstream from the fuel flow path and a second flow path downstream from the fuel flow path.

2. The solid oxide fuel cell of claim 1 wherein the capillary member includes a plurality of capillary passages spanning between the first and second flow paths to provide transfer of water by capillary action from an exhaust stream of the fuel cell to the fuel stream to the anode.

3. The solid oxide fuel cell of claim 2 further comprising a hydrocarbon fuel reformer in fluid communication between the first flow path and the fuel flow path.

4. The solid oxide fuel cell of claim 3 wherein the fuel reformer is a steam reformer or autothermal reformer.

5. The solid oxide fuel cell of claim 2 wherein the capillary member is planar.

6. The solid oxide fuel cell of claim 2 wherein the capillary member is tubular.

7. The solid oxide fuel cell of claim 2 wherein the smallest dimension of the capillary passages is between about 0.1 and about 5 μm.

8. The solid oxide fuel cell of claim 2 wherein a substantial portion of the capillary member is inorganic material.

9. The solid oxide fuel cell of claim 8 wherein a substantial portion of the capillary member is selected from group consisting of stainless steel, nickel alloys, cobalt alloys and combinations thereof.

10. The solid oxide fuel cell of claim 1 wherein the capillary member includes a first wetted surface in contact with the first flow path and a second wetted surface in contact with the second flow path for facilitating evaporation and condensation of water from the first and second flow paths respectively.

11. The solid oxide fuel cell of claim 10 wherein the wetted surface area of the first flow path is substantially greater than the wetted surface area of the second flow path.

12. A method for operating a solid oxide fuel cell system with a hydrocarbon fuel comprising:
humidifying a hydrocarbon fuel stream provided to a fuel reforming portion of the solid oxide fuel cell system by passively transferring water from an exhaust gas of the fuel cell to the hydrocarbon fuel stream.

13. The method of claim 12 wherein the water is passively transferred through a water permeable member disposed between a first flow path downstream from the fuel reforming portion to a second flow path upstream from the fuel reforming portion.

14. The method of claim 13 wherein the fuel reforming portion includes a steam reformer.

15. The method of claim 13 further comprising forming a liquid barrier between the first and second flow paths by providing liquid water in capillary passages formed in the water permeable member between the first and second flow paths.

16. The method of claim 15 wherein the capillary passages are configured to retain liquid water therein when the pressure drop across the passages is at least about 5 psi.

17. The method of claim 12 wherein substantially all of the fuel in the fuel stream is converted in the fuel cell system such that the exhaust gas of the fuel cell is primarily water and carbon dioxide, the method further comprising removing a substantial portion of the water from the exhaust gas to thereby provide a substantially pure outlet stream of carbon dioxide.

18. The method of claim 17 wherein the substantially pure outlet stream is at least about 90 molar % carbon dioxide.

19. A system comprising:
a solid oxide fuel cell, a fuel reformer, and a capillary humidifier;
wherein the capillary humidifier is configured to passively transfer water from an exhaust stream of the solid oxide fuel cell to an inlet stream to the fuel reformer.

20. The system of claim 19 wherein the capillary humidifier includes a wetted capillary member forming a diffusion barrier between the exhaust stream of the solid oxide fuel cell and the inlet stream to the fuel reformer.

21. The system of claim 20 wherein the wetted capillary member is a rigid inorganic structure having openings therethrough.

22. The system of claim 21 wherein the capillary member is generally planar or generally cylindrical.

23. The system of claim 21 wherein the capillary member is a metal, alloy or ceramic.

24. The system of claim 21 wherein the openings are sized are configured to retain water therein against a pressure drop across the capillary member up to at least about 7 psi.

25. The system of claim 24 wherein the openings are a multiplicity of openings all of substantially uniform size.

26. The system of claim 21 wherein the fuel reformer is integrally formed with a solid oxide fuel cell stack.
